(19) United States
(12) Patent Application Publication
(10) Pub. No.: US 2005/0169546 A1
(43) Pub. Date: Aug. 4, 2005

(54) Monitoring system and method for using the same

(75) Inventors: Sung-chol Shin, Gyeonggi-do (KR); Woo-jin Han, Gyeonggi-do (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/032,014

(22) Filed: Jan. 11, 2005

(30) Foreign Application Priority Data
Jan. 29, 2004 (KR) 10-2004-0005821

(51) Int. Cl. G06K 9/36

(52) U.S. Cl. 382/239

(57) ABSTRACT

A monitoring system and method. The monitoring system includes an encoder that performs scalable video coding on a photographed image of a monitored region, a predecoder that processes a bitstream containing information on the quality of the coded image into a form suitable for an image quality level required for decoding and outputs the same, a decoder that decodes the output bitstream, and a controller that controls image quality level required for decoding. Therefore, the amount of image data recorded can be reduced while obtaining high quality data for an image photographed upon occurrence of a specified event, transmitting the photographed image data over a low bandwidth, and reducing the amount of computation in adjusting the quality of an image to be displayed and/or stored.

### CROSS REFERENCE TO RELATED APPLICATION

This application claims priority from Korean Patent Application No. 10-2004-0005821 filed on Jan. 29, 2004 in the Korean Intellectual Property Office, the disclosure of which is incorporated herein by reference in its entirety.

### BACKGROUND OF THE INVENTION

1. Field of the Invention

The present invention relates to a monitoring system, and more particularly to a monitoring system and a method for using the same.

2. Description of the Related Art

Monitoring systems are widely used in department stores, banks, factories, and exhibition halls as well as private residences to prevent theft or robbery or easily check the operations of machines and process flows. Monitoring systems employ one or more imaging devices to photograph a plurality of regions being monitored and display the same through a monitor installed in a central control room for management. Monitoring systems also store recorded image data for future use, e.g., when a particular event needs to be verified.

In general, image data requires a large capacity storage medium and a wide bandwidth for transmission since the amount of multimedia data is usually large. For example, a 24-bit true color image having a resolution of 640*480 needs a capacity of 640*480*24 bits, i.e., data of about 7.37 Mbits, per frame. When this image is transmitted at a speed of 30 frames per second, a bandwidth of 221 Mbits/sec is required. When a 90-minute movie based on such an image is stored, a storage space of about 1200 Gbits is required. Accordingly, a compression coding method is a requisite for transmitting image data including text, video, and audio.

A basic principle of data compression lies in removing data redundancy. Data can be compressed by removing spatial redundancy in which the same color or object is repeated in an image, temporal redundancy in which there is little change between adjacent frames in a moving image or the same sound is repeated in audio, or mental visual redundancy taking into account human eyesight and perception due to high frequency.

Data compression can be classified into lossy/lossless compression according to whether source data is lost, intraframe/interframe compression according to whether individual frames are compressed independently, and symmetric/asymmetric compression according to whether time required for compression is the same as time required for recovery. For text or medical data, lossless compression is usually used. For multimedia data, lossy compression is usually used. Meanwhile, intraframe compression is usually used to remove spatial redundancy, and interframe compression is usually used to remove temporal redundancy.

A compression coding technique is essentially required for transmission and storage of image data. Video compression algorithms not only reduce the transmission bandwidth of image data but also increase utilization of storage media for storing the image data.

In general, in order to improve the security achieved by a monitoring system the number of imaging devices is increased. Video signals sent from a plurality of imaging devices are compressed through the use of a video compression technique and stored in a storage system for later use. However, even a compressed video signal contains a large amount of data and needs more storage capacity as the number of imaging devices increases or the length of time of the video increases.

In order to decrease the amount of image data, some monitoring systems are designed to encode photographed images at low visual quality or at a low frame rate, thereby causing a scene related to a particular event to be stored at a low visual quality or frame rate. This makes it difficult to accurately read desired information through a video screen, which may hamper the inherent function of a monitoring system.

A monitoring system is mainly intended to facilitate monitoring of a plurality of regions and store pertinent information upon occurrence of a specified event (e.g., intrusion detection or machine malfunction within a factory) for verification of the same situation at the date and time of occurrence when necessary). Thus, it is necessary to take a video of a monitored region and store the photographed image at a high frame rate and visual quality. However, storing the remaining images photographed during most of the time when no specified event occurs is an extreme waste of space in a storage system.

Meanwhile, in order to simultaneously display multi-channel images received from an imaging device, a monitoring system partitions a monitor screen into multiple regions (e.g., 4 or 16 regions) and simultaneously displays video signals transmitted over multiple channels on the screen.

To this end, a decoder reconstructs transmitted image data for each video signal and makes low resolution of the reconstructed image according to the resolution of each partitioned region on the screen for display. Furthermore, upon occurrence of a specified event or upon a user's request, a video image on the appropriate region of the screen is upscaled for display while images on the remaining regions may be downscaled or not displayed for a predetermined period of time. Performing the above operation on large capacity video signals increases the computational burden of the decoder.

Since a conventional monitoring system has suffered various problems according to the type of application as described above, there is a need for a method of efficiently using a monitoring system.

### SUMMARY OF THE INVENTION

The present invention provides a monitoring system and method that uses a scalable video coding technique to display and store an image that is photographed at low visual quality or at a low frame rate and that is photographed at high resolution or visual quality or at a high frame rate upon occurrence of a specified event.

According to an exemplary embodiment of the present invention, there is provided a monitoring system comprising an encoder that performs scalable video coding on a photographed image of a monitored region, a predecoder that processes a bitstream containing information on the quality of the coded image into a form suitable for an image quality level required for decoding and outputs the same, a decoder that decodes the output bitstream, and a controller that controls an image quality level required for decoding.

The monitoring system may further comprise an event detecting sensor that detects the occurrence of a specified event in the monitored region, a multi-image processor that partitions a single display screen into a plurality of sub screens and adjusts a position where the decoded image will be displayed, and a storage unit that stores the decoded image. In this case, a controller for controlling the image quality level required for decoding is further provided at a terminal of the encoder.

The controller preferably adjusts the image quality level required for decoding automatically upon occurrence of a specified event or upon a user's request, and the image quality is preferably determined by resolution, visual quality, or frame rate.

Preferably, an image of a monitored region where the specified event has occurred or requested by the user is displayed or stored at high resolution, high visual quality, or high frame rate. Images of regions except the monitored region where the specified event has occurred or requested by the user are displayed or stored at low resolution, low visual quality, or a low frame rate.

According to another exemplary embodiment of the present invention, there is provided a method of using a monitoring system, the method comprising performing scalable video coding on a photographed image of a monitored region, processing a bitstream containing quality of the coded image into a form suitable for image quality level required during decoding for predecoding, decoding the processed bitstream, and controlling the image quality level required for decoding.

The image quality required for decoding is preferably adjusted automatically upon occurrence of a specified event or upon a user's request. In addition, the image quality level is preferably determined by resolution, visual quality, or frame rate.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a monitoring system according to a first embodiment of the present invention;

FIG. 2 is a schematic block diagram of a conventional scalable video encoder;

FIG. 3 is a block diagram of a monitoring system according to a second embodiment of the present invention;

FIG. 4 is a block diagram of a monitoring system according to a third embodiment of the present invention;

FIG. 5 is a block diagram of a monitoring system according to a fourth embodiment of the present invention; and

FIG. 6 is a flowchart illustrating a method of using a monitoring system according to an embodiment of the present invention.

### DETAILED DESCRIPTION OF THE PREFERRED EMBODIMENTS

A monitoring system and a method of using the system will now be described in detail with reference to the accompanying drawings.

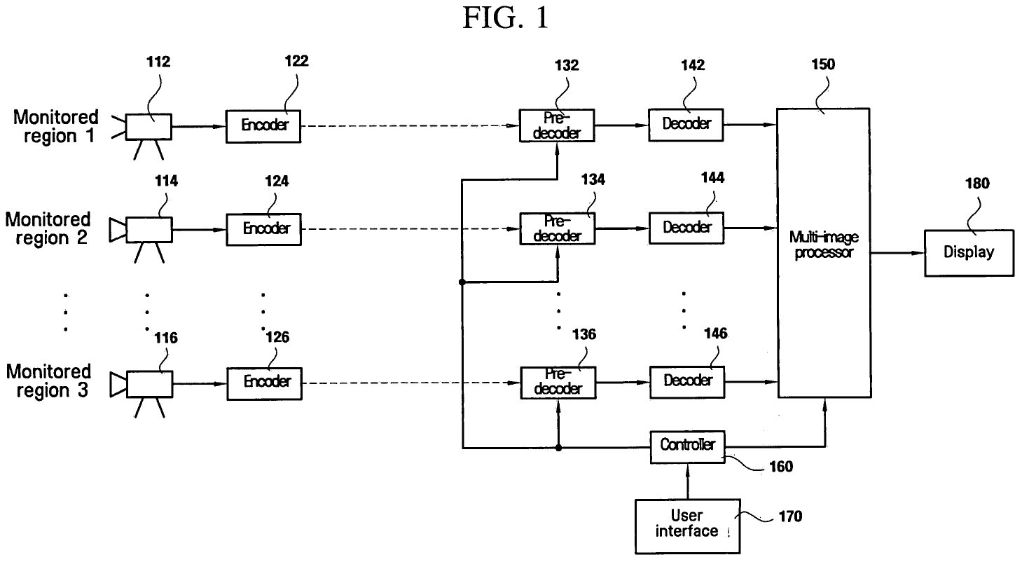

FIG. 1 is a block diagram of a monitoring system according to a first embodiment of the present invention. Referring to FIG. 1, the monitoring system includes a plurality of imaging devices 112, 114, . . . , and 116 that photograph a plurality of monitored regions 1 through n, encoders 122, 124, . . . , and 126 that encode images produced by the plurality of imaging devices 112, 114, . . . , and 116 using a scalable video encoding technique, predecoders 132, 134, . . . , and 136 that perform a predetermined process on the received bitstream in such a way as to adjust the frame rate, visual quality and resolution of the bitstream to be decoded, decoders 142, 144, . . . , and 146 that decode encoded video signals, a multi-image processor 150 that partitions a screen in order to designate locations on the screen where a plurality of images will be displayed, a controller 160 that controls the operations of the predecoders 132, 134, . . . , and 136 and the multi-image processor 150 upon a user's request or upon occurrence of a specified event, a user interface 170 that delivers the user's request to the controller 160, and a display 180 that displays the decoded images.

The plurality of imaging devices 112, 114, . . . , and 116 are installed in the monitored regions 1 through n for photographing.

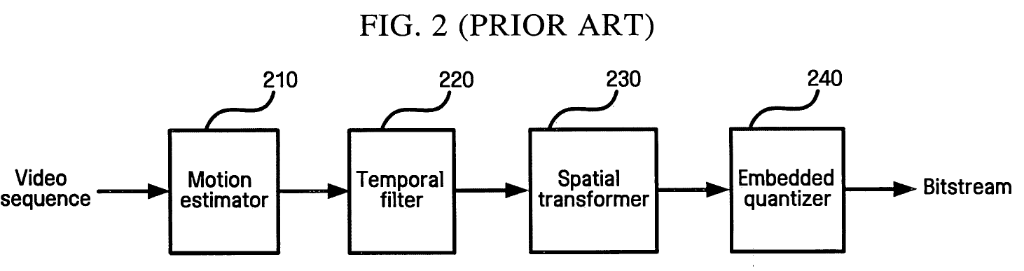

The encoders 122, 124, . . . , and 126 perform scalable video coding on video signals produced by the imaging devices 112, 114, . . . , and 116. Scalable video coding enables a single compressed bitstream to be partially encoded at multiple resolutions, qualities, and frame rates and has emerged as a promising approach that allows efficient signal representation and transmission in a very changeable communication environment. A scalable video encoder will now be described with reference to FIG. 2.

FIG. 2 is a schematic block diagram of a conventional scalable video encoder.

Referring to FIG. 2, a motion estimator 210 compares blocks in a current frame being subjected to motion estimation with blocks of reference frames corresponding there to, and obtains the optimum motion vectors for the current frame.

A temporal filter 220 performs temporal filtering of frames using information on motion vectors determined by the motion estimator 210. For temporal filtering, Motion Compensated Temporal Filtering (MCTF), Unconstrained MCTF (UMCTF), and other temporal redundancy removal techniques that provide temporal scalability may be used. Temporal scalability refers to the ability to adjust the frame rate of motion video.

A spatial transformer 230 removes spatial redundancies from the frames from which the temporal redundancies have been removed or that have undergone temporal filtering. Spatial scalability must be provided in removing the spatial redundancies. Spatial scalability refers to the ability to adjust video resolution, for which a wavelet transform is used.

In a currently known wavelet transform, a frame is decomposed into four sections (quadrants). A quarter-sized image (L image), which is substantially the same as the entire image, appears in a quadrant of the frame, and information (H image), which is needed to reconstruct the entire image from the L image, appears in the other three quadrants.

In the same way, the L frame may be decomposed into a quarter-sized LL image and information needed to reconstruct the L image. Image compression using the wavelet transform is applied to the JPEG 2000 standard, and removes spatial redundancies between frames. Furthermore, the wavelet transform enables original image information to be stored in the transformed image, which is a reduced version of the original image, thereby allowing video coding that provides spatial scalability.

The temporally filtered frames are converted to transform coefficients by spatial transformation. The transform coefficients are then delivered to an embedded quantizer 240 for quantization. The embedded quantizer 240 performs embedded quantization to convert the real transform coefficients into integer transform coefficients.

By performing embedded quantization on transform coefficients, it is possible to not only reduce the amount of information to be transmitted but also achieve signal-to-noise ratio (SNR) scalability. SNR scalability refers to the ability to adjust video quality. The term “embedded” is used to indicate that a coded bitstream includes quantization. In other words, compressed data is created in the order of visual importance or tagged by visual importance. The actual quantization (visual importance) levels can be a function of a decoder or a transmission channel.

If the bandwidth, storage capacity, and display resources allow, the image can be reconstructed losslessly. Otherwise, the image is quantized only as much as allowed by the most limited resource. Embedded quantization algorithms currently in use are EZW, SPIHT, EZBC, and EBCOT. In the illustrative embodiment, any known algorithm can be used.

As described above, use of the scalable video encoding technique enables a decoder to freely adjust resolution, visual quality, or frame rate of video when necessary. To achieve this function, a predecoder is needed.

Each of the predecoders 132, 134, . . . , and 136 truncates a portion of the incoming bitstream to be decoded.

For a video signal encoded by a scalable video coding technique that provides temporal, spatial, and SNR scalabilities, each of the predecoders 132, 134, . . . , and 136 removes a portion of the bitstream upon request from the controller 160 and delivers a bitstream whose resolution, visual quality, and frame rate have been adjusted to the corresponding decoder 142, 144, . . . , or 146.

That is, each of the predecoders 132, 134, . . . , and 136 removes a portion of the bitstream in such a way as to satisfy the preset resolution, visual quality, and frame rate. Since an image of each of the monitored regions 1 through n has a low importance level during the normal time when no specified event occurs, each of the predecoders 132, 134, . . . , and 136 preferably processes the bitstream in such a way as to reconstruct a video signal at low visual quality or at a low frame rate. Thus, an image of each of the monitored regions 1 through n is displayed and stored at low visual quality. In this case, the amount of decoded data and thus the storage space are small.

Furthermore, when a screen is partitioned into a plurality of regions to simultaneously display a plurality of images, each of the predecoders 132, 134, . . . , and 136 allows the reconstructed image to maintain a low level of resolution by removing a portion of a bitstream, in order to adjust the resolution of an image to be decoded according to the size of a partitioned region on the screen.

The decoders 142, 144, . . . , and 146 decode bitstreams received from the predecoders 132, 134, . . . , and 136, respectively, in a reverse order to the order the encoders 122, 124, . . . , and 126 encode the video signals.

The multi-image processor 150 partitions a screen in such a way as to simultaneously display images received from the plurality of decoders 142, 144, . . . , and 146 on the single screen and adjusts positions where the images will be displayed among the partitioned screen regions. The display 180 displays the plurality of images on a single screen.

The controller 160 controls the operation of the each of the predecoders 132, 134, . . . , and 136 in such a manner that upon occurrence of a specified event, an image of the appropriate monitored region is displayed at higher resolution, quality, or frame rate than normal. Furthermore, the controller 160 controls the multi-image processor 150 in such a way as to adjust the number of regions on a screen and the location of each image displayed according to varying resolutions of each image.

For example, when a user requests an image of the monitored region 1 for close scrutiny through the user interface 170, the controller 160 allows the first predecoder 132 to simply pass an incoming bitstream without any modification. In this case, since a bitstream corresponding to a video signal of the monitored region 1 is input as it is encoded to the decoder 142 for decoding, an image of the monitored region 1 is displayed or stored at increased visual quality or at an increased frame rate.

This increases the video resolution, which allows the image of the monitored region 1 to be enlarged for display or storage. In this case, the controller 160 controls the operation of each of the predecoders 132, 134, . . . , and 136 such that images of the remaining monitored regions 2 through n are displayed or stored at lower quality. When an image of a monitored region where a specified event occurs is displayed on the entire screen due to the increased resolution, the controller 160 may control the multi-image processor 150 to display no images of the remaining regions for a short time.

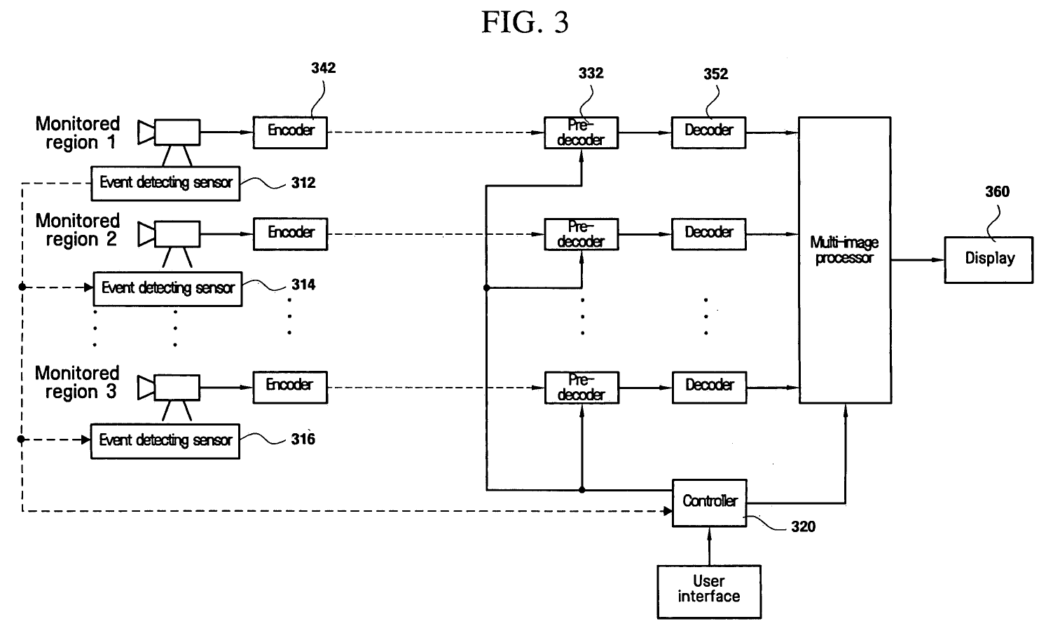

FIG. 3 is a block diagram of a monitoring system according to a second embodiment of the present invention.

Referring to FIG. 3, which schematically illustrates a monitoring system according to a second embodiment, event detecting sensors 312, 314, . . . , and 316 are installed in the monitored regions 1 through n shown in the monitoring system of FIG. 1, respectively, and detects an unauthorized intruder or machine malfunction which are then forwarded to a controller 320. The event detecting sensors 312, 314, . . . , and 316 may be infrared sensors, optical sensors, or various other devices designed to detect a specified event.

When the event detecting sensor 312 in the monitored region 1 detects a specified event and alerts the controller 320 of the event, the controller 320 automatically controls the operation of the corresponding predecoder 332 such that the entire bitstream representing a video signal received from the monitored region 1 is delivered to a decoder 352. In this case, the bitstream received from the encoder 342 corresponding to the monitored region 1 is forwarded to the decoder 352 without being processed for decoding, and an image of the monitored region 1 can be displayed at high quality.

That is, the image of a region where a specified event occurs is decoded at a high frame rate, at high visual quality, and with high resolution and then automatically enlarged for display on the entire screen of a display 360. Thus, it is possible for a user to monitor a high quality image of the relevant region. Furthermore, by storing the image photographed upon occurrence of the specified event in a storage unit (not shown) at high quality, it is possible to precisely scrutinize the event when verification of the event is required later.

While the entire bitstream containing an image of the region where a specified event occurs is decoded without any adjustment by a predecorder in the illustrative embodiments shown in FIGS. 1 and 3, the present invention will not be limited to this. For example, when the image photographed upon occurrence of the specified event is displayed at higher quality (high visual quality, high resolution, or high frame rate) than normal, the predecoder may perform an appropriate modification process on a bitstream forwarded from the appropriate region.

Furthermore, when the resolution of the image of the relevant region is increased, the controller may control the operation of each predecoder such that images of the remaining regions (monitored region 2 through n in the illustrative embodiment of FIG. 3) can be displayed at lower quality or frame rate than the previous one.

In this way, various combinations of resolutions, qualities, and frame rates of images photographed upon occurrence of the specified event and during other normal time can be obtained. Thus, displaying and storing images that are differentiated in quality (resolution, visual quality, or frame rate) depending on whether the images are photographed upon occurrence of a specified event or during other times, will be construed as being included in the present invention.

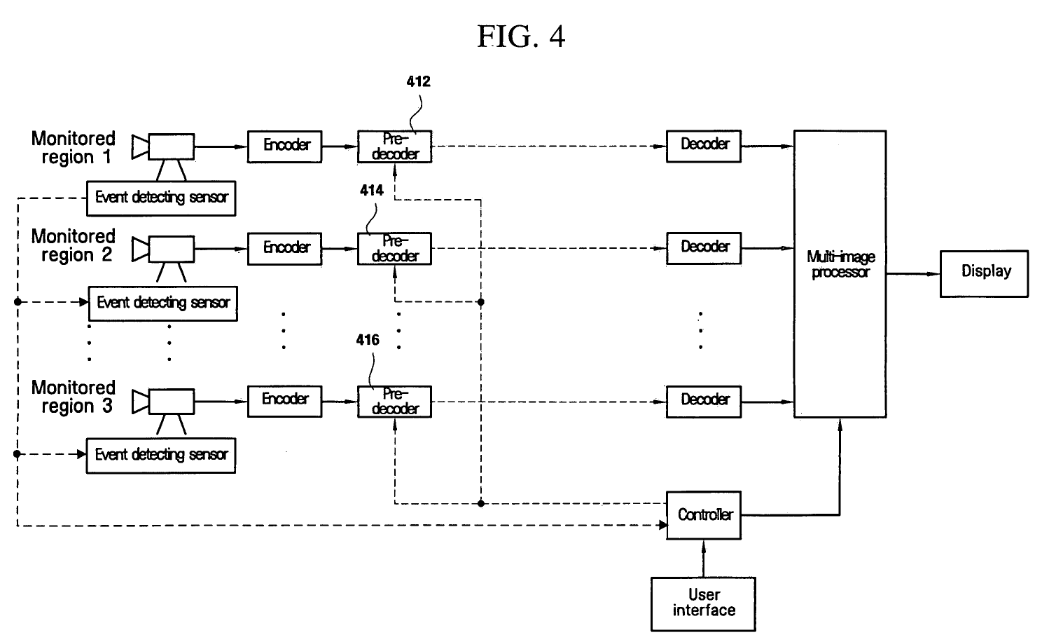

FIG. 4 is a block diagram of a monitoring system according to a third embodiment of the present invention.

Referring to FIG. 4, components of a monitoring system according to a third embodiment of the present invention have the same functions and constructions as those described with references to FIG. 1 or 3 except that predecoders 412, 414, . . . , and 416 are located at the terminals of the encoders. Positioning each of the predecoders 412, 414, . . . , and 416 at the terminals of the encoders allows a portion of an encoded bitstream to be removed by the predecoder for delivery to the decoder, thereby reducing the transmission bandwidth that is transmitted to the decoders. Thus, when the condition of a network between terminals of the encoders that photograph monitored regions, and encode the same for transmission and a decoding terminal that decodes video bitstreams received from each terminal of the encoder for display or storage is unfavorable (e.g., the decoders are located remotely from the encoders), it may be more efficient to locate the predecoder at the terminal of the encoder.

In each of the illustrative embodiments, the encoding and decoding terminals may be connected via a wired or wireless network.

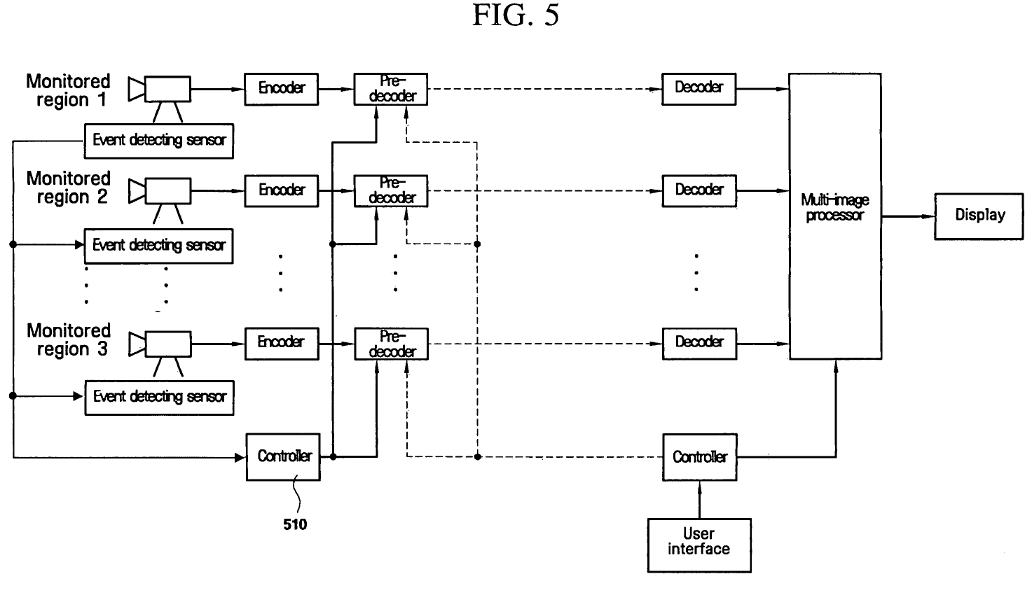

Furthermore, when a predecoder is located at a terminal of the encoder, it is possible to position a controller in the terminal of the encoder, which automatically controls the operation of the predecoder according to an alarm signal of a detecting sensor. A monitoring system thus configured is shown in FIG. 5.

FIG. 5 is a block diagram of a monitoring system according to a fourth embodiment of the present invention.

Referring to FIG. 5, an event detecting sensor that detects the occurrence of a specified event sends a detection signal to a controller 510 that automatically controls the operation of each predecoder, thereby adjusting the image quality of each monitored region to be displayed on a display or stored in a storage unit.

Furthermore, the monitoring systems according to the embodiments of the present invention include storage units for storing image data to be decoded through each decoder.

As described above, an image photographed upon occurrence of a specified event is stored at high quality while that photographed during normal time is stored at low quality.

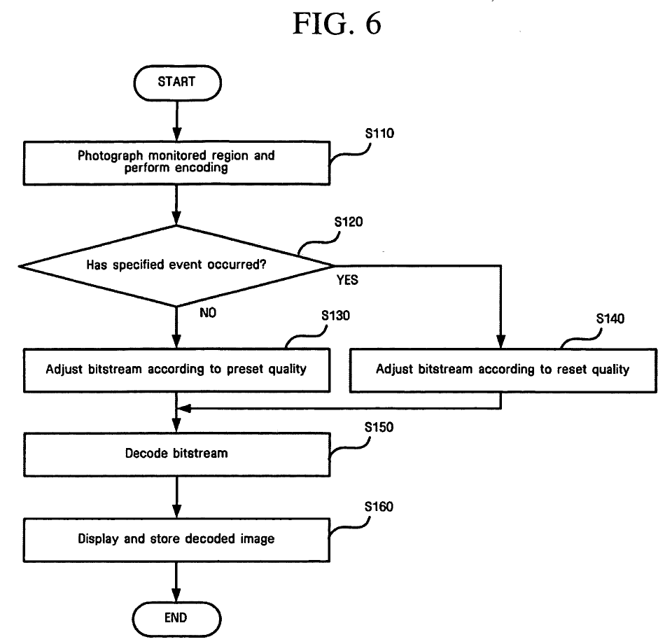

FIG. 6 is a flowchart illustrating a method of using a monitoring system according to an embodiment of the present invention.

Referring to FIG. 6, which is a flowchart illustrating a method for using a monitoring system according to an embodiment of the present invention, in step S110, video signals produced during photographing of respective imaging devices are encoded by respective encoders. In this case, encoding is performed using a scalable video encoding technique. A controller determines the occurrence of a specified event in step S120, and if no specified event has occurred, controls the operation of each predecoder to adjust a bitstream to be decoded so that an image is reconstructed at a preset quality in step S130. It is preferable that a bitstream is adjusted in such a way as to display and store an image of each monitored region during normal time at low quality. The bitstream whose quality has been adjusted by the predecoder is decoded by each decoder in step S1150, and displayed and stored in step S160.

In step S140, upon occurrence of the specified event, the controller allows the predecoder corresponding to the appropriate region to adjust a bitstream so that an image can be decoded at high quality in order to display and store the image of the region where the specified event occurs at high quality. In this case, the controller may control the predecoder to adjust a bitstream to be decoded so that images of the remaining regions are reconstructed at lower quality that the previous one. In step S150, the bitstream adjusted by the predecoder is decoded by each decoder of a decoding terminal, and displayed and stored in step S160.

The occurrence of the specified event is checked by a user's request for an image of a specified region or an alarm signal generated by an event detecting sensor installed in each region.

In concluding the detailed description, those skilled in the art will appreciate that many variations and modifications can be made to the preferred embodiments without substantially departing from the principles of the present invention. Therefore, the disclosed preferred embodiments of the invention are used in a generic and descriptive sense only and not for purposes of limitation.

The above-described embodiments use a scalable video coding technique to allow an image photographed during normal time to be displayed and stored at low quality, i.e., a low frame rate and visual quality, while allowing an image photographed upon occurrence of a specified event to be displayed and stored at high quality, i.e., at a high resolution, visual quality, and frame rate. This makes it possible to efficiently store and use the photographed images.

1. A monitoring system comprising:
an encoder that performs scalable video coding on a photographed image of a monitored region;
a predecoder that processes a bitstream containing quality information of the coded image into a form suitable for an image quality level required for decoding and outputs the processed bitstream;
a decoder that decodes the output bitstream to provide a decoded image; and
a controller that controls the image quality level required for decoding.

2. The monitoring system of claim 1, further comprising:
an event detecting sensor that detects the occurrence of a specified event in the monitored region;
a multi-image processor that partitions a single display screen into a plurality of sub screens and adjusts a position where the decoded image will be displayed; and
a storage unit that stores the decoded image.

3. The monitoring system of claim 2, wherein the controller for controlling the image quality level required for decoding is further provided at a terminal of the encoder.

4. The monitoring system of claim 2, wherein the controller adjusts the image quality level required for decoding automatically upon occurrence of the specified event.

5. The monitoring system of claim 4, wherein the image quality is determined by at least one of a resolution, a visual quality, and a frame rate.

6. The monitoring system of claim 5, wherein an image of a monitored region where the specified event has occurred is displayed with at least one of a high resolution, a high visual quality, and a high frame rate.

7. The monitoring system of claim 6, wherein images of regions except the monitored region where the specified event has occurred are displayed with at least one of a low resolution, low visual quality, or low frame rate.

8. The monitoring system of claim 1, further comprising a user interface operable for allowing a user to adjust the image quality level for decoding upon occurrence of the specified event.

9. The monitoring system of claim 2, further comprising a user interface operable for allowing a user to adjust the image quality level for decoding upon occurrence of the specified event.

10. The monitoring system of claim 5, wherein an image of a monitored region where the specified event has occurred is stored with at least one of a high resolution, a high visual quality, and a high frame rate.

11. The monitoring system of claim 6, wherein images of regions except the monitored region where the specified event has occurred are stored with at least one of a low resolution, low visual quality, or low frame rate.

12. A method for using a monitoring system, the method comprising:
performing scalable video coding on a photographed image of a monitored region;
processing with a predecoder a bitstream containing quality information of the coded image into a form suitable for an image quality level required for decoding;
controlling the image quality level required for decoding; and
decoding the processed bitstream.

13. The method of claim 12, wherein the image quality required for decoding is adjusted automatically upon occurrence of a specified event.

14. The method of claim 13, wherein the image quality level is determined by at least one of a resolution, a visual quality, and a frame rate.

15. The method of claim 14, wherein an image of a monitored region where the specified event has occurred is displayed with at least one of a high resolution, a high visual quality, and a high frame rate.

16. The method of claim 15, wherein images of regions except the monitored region where the specified event has occurred are displayed with at least one of a low resolution, a low visual quality, and a low frame rate.

17. The method of claim 12, wherein the image quality required for decoding is adjusted by a user upon occurrence of a specified event.

18. The method of claim 14, wherein an image of a monitored region where the specified event has occurred is stored with at least one of a high resolution, a high visual quality, and a high frame rate.

19. The method of claim 15, wherein images of regions except the monitored region where the specified event has occurred are stored with at least one of a low resolution, a low visual quality, and a low frame rate.

20. A method of monitoring comprising:
encoding using scalable video coding a photographed image of a monitored region;
pre-decoding the encoded image with a predetermined coding quality in accordance with an occurrence of a specified event to provide an pre-decoded image; and
decoding the pre-decoded image.

21. The method of claim 20, wherein the predetermined coding quality is a first quality upon occurrence of the specified event, and is a second quality different from the first quality if the specified event does not occur.

22. The method of claim 21, wherein the second quality is inferior to the first quality.

23. The method of claim 22, wherein the second quality is inferior to the first quality in at least one of resolution, visual quality, and frame rate.
